(19) United States
(12) Patent Application Publication
(10) Pub. No.: US 2010/0031302 A1
(43) Pub. Date: Feb. 4, 2010

(54) STREAM DISTRIBUTION SYSTEM, STREAM RECEIVING DEVICE, AND STREAM REPRODUCTION METHOD

(75) Inventor: Kaoru UKAI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/398,021

(22) Filed: Mar. 4, 2009

(30) Foreign Application Priority Data
Jul. 30, 2008 (JP) 2008-196648

(51) Int. Cl. H04N 7/173

(52) U.S. Cl. 725/110; 725/116

(57) ABSTRACT

According to one embodiment, a stream distribution system includes a distribution server that distributes content via streaming through a network, and a stream receiving device that receives the content from the distribution server. The distribution server includes a data distributor that distributes stream data of the content in response to a transmission request from the stream receiving device together with low bit-rate specific reproduction data. The specific reproduction data is tagged with a timestamp equivalent to that of the stream data and generated from the stream data. The stream receiving device includes a reproducer that switches reproduction output between the stream data and the specific reproduction data received from the distribution server while establishing reproduction synchronization between the stream data and the specific reproduction data based on the timestamp.

### CROSS-REFERENCE TO RELATED APPLICATIONS

This application is based upon and claims the benefit of priority from Japanese Patent Application No. 2008-196648, filed Jul. 30, 2008, the entire contents of which are incorporated herein by reference.

### BACKGROUND

1. Field

One embodiment of the invention relates to a stream distribution system, a stream receiving device, and a streaming reproduction method.

2. Description of the Related Art

In recent years, Internet protocol television (IPTV) has increasingly become popular. IPTV is television broadcast technology that delivers digital content, such as video and audio, via streaming over an Internet protocol (IP) network such as the Internet (see, Japanese Patent Application Publication (KOKAI) No. 2004-64330).

In general, fast-forward (FF) reproduction of data from a storage module such as HDD or DVD is implemented by displaying a reference picture contained in the data. In the case of reproduction of data from such a storage module, the data transfer rate is high, and a reference picture in the data can be randomly accessed, which enables supply of data for FF reproduction without interruption.

On the other hand, in the case of reproduction of an IPTV stream, there is a need for transmitting a request for data to a server to perform FF reproduction. Accordingly, data acquisition takes a longer time, and a time lag occurs in the response of FF reproduction. That is, in IPTV, it is not likely that FF reproduction is performed with the same quality as that of data from a storage module such as HDD or DVD.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a stream distribution system according to a first embodiment of the invention;

FIG. 2 is an exemplary block diagram of a hardware configuration of the stream distribution system in the first embodiment;

FIG. 3 is an exemplary sequence chart of a reproduction process in the first embodiment;

FIG. 4 is an exemplary flowchart of an FF data storing/discarding process in the first embodiment;

FIG. 5 is an exemplary flowchart of an FF reproduction process in the first embodiment;

FIG. 6 is an exemplary block diagram of a hardware configuration of a stream distribution system according to a second embodiment of the invention;

FIG. 7 is an exemplary sequence chart of a reproduction process in the second embodiment; and

FIG. 8 is an exemplary flowchart of an FF reproduction process in the second embodiment.

### DETAILED DESCRIPTION

Various embodiments according to the invention will be described hereinafter with reference to the accompanying drawings. In general, according to one embodiment of the invention, a stream distribution system comprises: a distribution server configured to distribute content via streaming through a network; and a stream receiving device configured to receive the content from the distribution server. The distribution server comprises a data distributor configured to distribute stream data of the content in response to a transmission request from the stream receiving device together with low bit-rate data for specific reproduction as specific reproduction data. The specific reproduction data is tagged with a timestamp equivalent to a timestamp of the stream data and generated from the stream data. The stream receiving device comprises a reproducer configured to switch, upon receipt of the stream data and the specific reproduction data from the distribution server, between reproduction output of the stream data and reproduction output of the specific reproduction data while establishing reproduction synchronization between the stream data and the specific reproduction data based on the timestamp.

According to another embodiment of the invention, a stream receiving device comprises: a receiver configured to receive stream data of content distributed from a distribution server via a network together with low bit-rate data for specific reproduction as specific reproduction data, the specific reproduction data being tagged with a timestamp equivalent to a timestamp of the stream data and generated from the stream data; and a reproducer configured to switch between reproduction output of the stream data and reproduction output of the specific reproduction data while establishing reproduction synchronization between the stream data and the specific reproduction data based on the timestamp.

According to still another embodiment of the invention, a streaming reproduction method comprises: receiving stream data of content distributed from a distribution server via a network together with low bit-rate data for specific reproduction as specific reproduction data, the specific reproduction data being tagged with a timestamp equivalent to a timestamp of the stream data and generated from the stream data; and establishing reproduction synchronization between the stream data and the specific reproduction data based on the timestamp and switching between reproduction output of the stream data and reproduction output of the specific reproduction data.

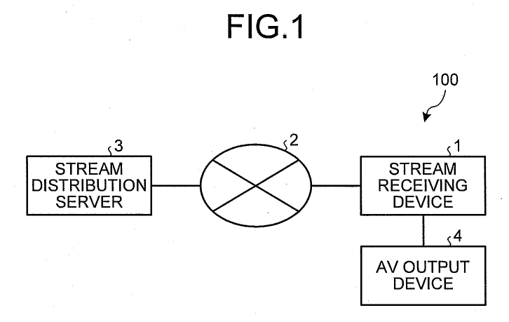

With reference to FIGS. 1 to 5, a description will be given of a first embodiment of the invention. In the following embodiments, a stream receiving device will be described as, for example, a TV tuner.

FIG. 1 is a schematic diagram of a stream distribution system 100 according to a first embodiment of the invention. As illustrated in FIG. 1, the stream distribution system 100 comprises a TV tuner as a stream receiving device 1 and a stream distribution server 3. The stream receiving device 1 is connected to the stream distribution server 3 via a network 2, which is an Internet protocol (IP) network such as the Internet. The stream receiving device 1 is also connected to an audio/video (AV) output device 4 such as a television. With this configuration, the stream receiving device 1 can acquire AV data of video content from the stream distribution server 3 through the network 2, and output it to the AV output device 4.

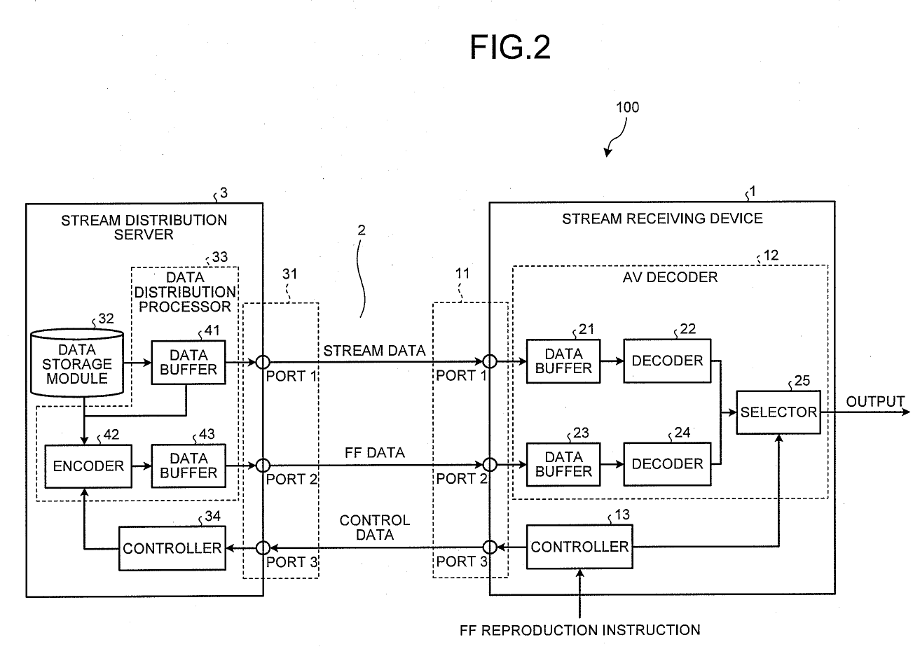

FIG. 2 is a block diagram of a hardware configuration of the stream distribution system 100. As illustrated in FIG. 2, the stream receiving device 1 comprises a communication module 11, an AV decoder 12, and a controller 13. The controller controls the operation of the communication module 11 and the AV decoder 12.

The communication module 11 functions as a receiver. The communication module 11 is connected to the network 2 using IPv6 as a communication protocol, and receives audio/video of video content from the stream distribution server 3. The AV decoder 12 functions as a reproducer, and decodes a video signal and an audio signal received by the communication module 11.

The AV decoder 12 comprises a data buffer 21, a decoder 22, a data buffer 23, a decoder 24, and a selector 25, the function of which will be described later.

Besides, as illustrated in FIG. 2, the stream distribution server 3 comprises a communication module 31, a data storage module 32, a data distribution processor 33, and a controller 34. The controller 34 controls the operation of the communication module 31, the data storage module 32, and the data distribution processor 33.

The data storage module 32 stores AV data of video content to be distributed via streaming. The data distribution processor 33 functions as a data distributor that retrieves AV data of video content from the data storage module 32 in response to a transmission request from a user, and distributes or delivers a stream of the AV data to the user. The communication module 31 is connected to the network 2 using IPv6 as a communication protocol, and transmits AV data of video content that is distributed by the data distribution processor 33.

The data distribution processor 33 comprises a data buffer 41, an encoder 42, and a data buffer 43, the function of which will be described later.

The communication module 11 of the stream receiving device 1 and the communication module 31 of the stream distribution server 3 each comprise a port for stream data and a port for data to be reproduced in FF mode (hereinafter, “FF data”), i.e., data to be reproduced in a specific mode (specific reproduction data). With this, during stream reproduction, a connection is established on the other port than that for stream data to communicate FF data. Thus, the operation efficiency can be improved.

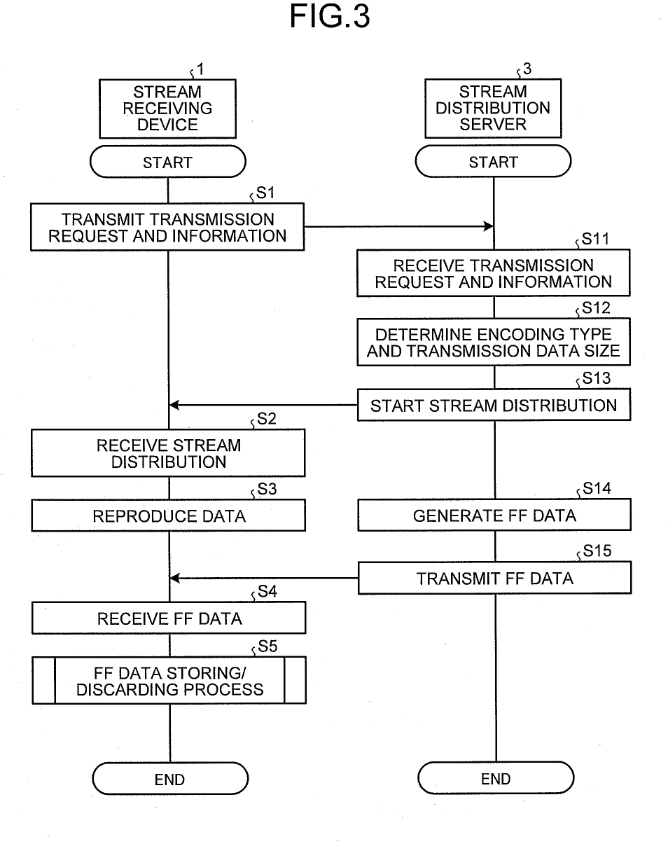

Described below is the operation of the stream distribution system 100 for stream reproduction. FIG. 3 is a sequence chart of the stream reproduction. As illustrated in FIG. 3, the controller 13 of the stream receiving device 1 transmits a transmission request to the stream distribution server 3 together with various types of information as information on the stream receiving device 1 (S1). Examples of the information include built-in decoder information, the size of a buffer for FF data, and the bit rate of the network.

Upon receipt of the transmission request and the information (S11), the controller 34 of the stream distribution server 3 determines encoding type and transmission data size based on the information received from the stream receiving device 1 (S12).

Thereafter, under the control of the controller 34, the data distribution processor 33 retrieves AV data (stream data) of video content from the data storage module 32 in response to the transmission request, and then starts stream distribution of the AV data (stream data) of the video content (S13).

Upon receipt of the stream distribution (S2), under the control of the controller 13, the AV decoder 12 decodes a video signal and an audio signal received through the stream distribution, and reproduces the signals (S3).

During the stream reproduction, under the control of the controller 34, the data distribution processor 33 retrieves the stream data from the data storage module 32 or the data buffer 41, the encoder 42 generates FF data from the stream data, and the data buffer 43 stores the FF data (S14). The FF data may be low bit-rate data obtained by image compression such as JPEG, or standard definition (SD)/quarter common intermediate format (QCIF) downscaling (resolution reduction).

Incidentally, by obtaining state information, such as the reproduction state of the stream receiving device 1, the state of the network, and the load on the stream receiving device 1, from the stream receiving device 1, the controller 34 of the stream distribution server 3 may modify FF data to be generated based on the state information.

In addition, if the controller 34 dynamically generates FF data according to speed information of FF data on the stream receiving device 1 side and transmits it to the stream receiving device 1, the fast-forward speed may be changed. As the data for changing the fast-forward speed, the stream distribution server 3 assigns an arbitrary number to FF data and thereby generates FF data for each speed. The stream receiving device 1 selects FF data indicative of a desired speed based on the number and reproduces it. Thus, the fast-forward speed can be changed. Alternatively, FF data may be discarded on the stream receiving device 1 side without being assigned such a number on the stream distribution server 3 side. In this case, for example, if the fast-forward speed is high, data may be discarded depending on the speed so that only necessary data can be output.

Under the control of the controller 34, the data distribution processor 33 transmits the FF data stored in the data buffer 43 to the stream receiving device 1 (S15). Before transmission of the FF data, the controller 34 adds a timestamp equivalent to that of the stream data to the FF data so that the stream receiving device 1 can establish reproduction synchronization between the stream data and the FF data.

The controller 13 of the stream receiving device 1 receives the FF data synchronously with the stream data (S4). During reproduction of the stream data, the controller 13 performs an FF data storing/discarding process, i.e., stores the FF data in the data buffer 23 and discards FF data therefrom in synchronization with the stream data (S5).

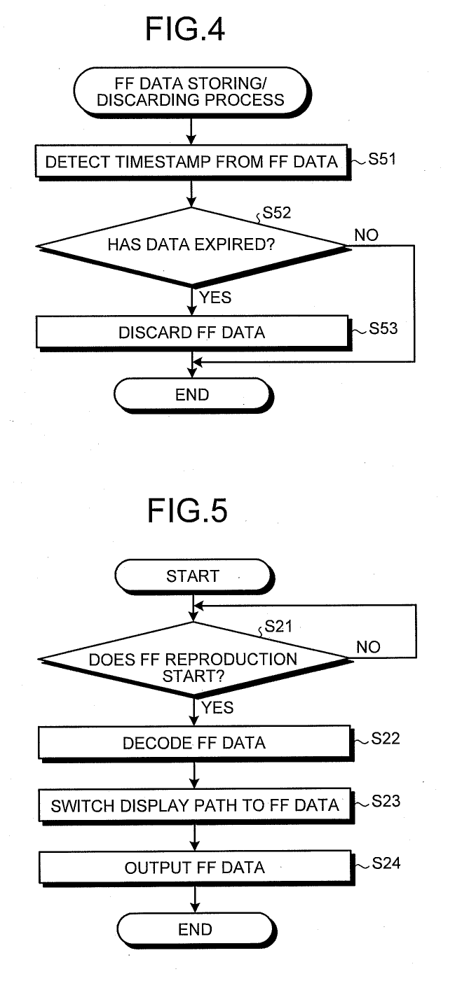

FIG. 4 is a flowchart of the FF data storing/discarding process performed at S5 in FIG. 3. As illustrated in FIG. 4, the controller 13 of the stream receiving device 1 detects a timestamp from FF data stored in the data buffer 23 (S51). Upon determining that the FF data has already expired based on the timestamp (Yes at S52), i.e., if the timestamp indicates a time before that indicated by the timestamp of stream data being reproduced, the controller 13 discards the FF data (S53).

FIG. 5 is a flowchart of an FF reproduction process. As illustrated in FIG. 5, having received an instruction to start FF reproduction through an operation module (not shown) provided to the stream receiving device 1 (Yes at S21), under the control of the controller 13, the AV decoder 12 starts decoding FF data by the decoder 24 (S22). The selector 25 switches the display path to the FF data (S23), and outputs the FF data to the AV output device 4 (S24).

Fast backward (FB) reproduction may be performed in a similar manner as described above. That is, on the stream distribution server 3 side, by using a port for data to be reproduced in FB mode, i.e., specific reproduction data, the same process is performed as in FF reproduction. On the stream receiving device 1 side, a storage buffer having a FIFO structure always stores update data and discards old data.

As described above, according to the first embodiment, in response to a transmission request from the stream receiving device 1, the stream distribution server 3 distributes or delivers stream data of content together with low bit-rate data for specific reproduction (specific reproduction data). The specific reproduction data is tagged with a timestamp and generated from the stream data. The stream receiving device 1 establishes reproduction synchronization between the stream data and the specific reproduction data based on the timestamp, and is allowed to freely switch between reproduction output of the stream data and reproduction output of the specific reproduction data. This eliminates the need for the stream receiving device 1 of having to transmit a request for data to the stream distribution server 3 to perform specific reproduction, such as FF reproduction and FB reproduction, during reproduction of the stream data. As a result, it is possible to prevent a time lag that occurs at the time of specific reproduction such as FF reproduction and FB reproduction. Thus, the same response can be achieved as in reproduction of data from a storage module.

In the first embodiment, while the FF data is described as being generated from the stream data by the encoder 42, this is by way of example only and not intended to be limiting. For example, the stream distribution server 3 may prepare in advance FF data corresponding to stream data. In this case, FF data is selected according to the state of the stream receiving device 1, and is transmitted to the stream receiving device 1.

Besides, the port for stream data or the port for FF data may also be used as an information port for reproduction control. In this case, prior to stream reproduction, information on the stream receiving device 1 is exchanged through the port for stream data as control data for stream reproduction, and settings on the stream distribution server 3 is determined based on the information. The port for FF data may also be used in a similar manner.

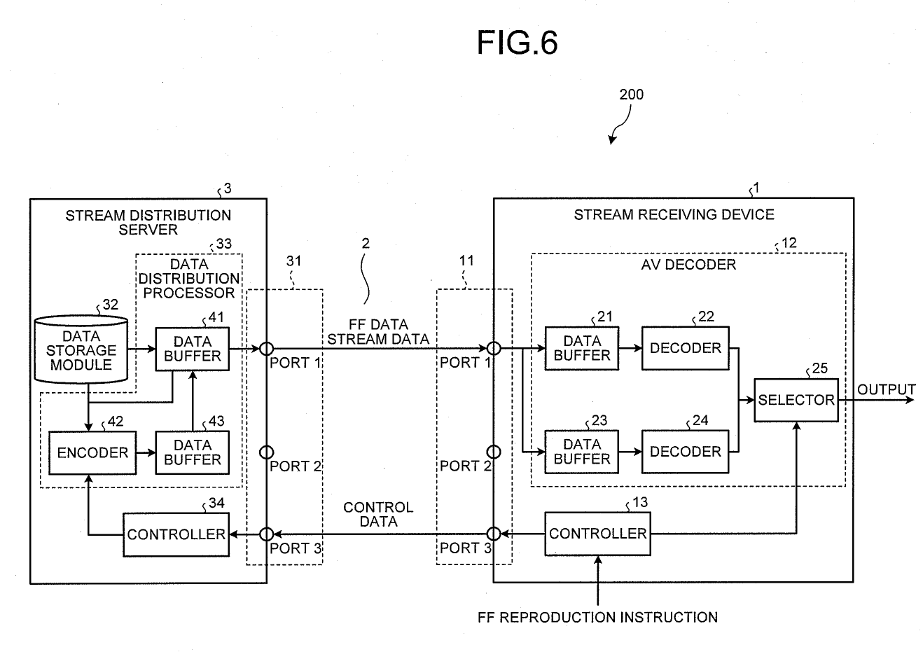

With reference to FIGS. 6 to 8, a description will be given of a second embodiment of the invention. The same or like parts as described in the first embodiment are identified by the same reference numerals, and their description will not be repeated.

FIG. 6 is a block diagram of a hardware configuration of a stream distribution system 200 according to the second embodiment. As illustrated in FIG. 6, in the second embodiment, stream data and FF data are exchanged through the same port.

Stream reproduction data (e.g., video data and audio data) can be identified by a stream ID (identification information). In other words, a reproduction device can select stream reproduction data to be output based on the stream ID, and reproduce it. Therefore, in the second embodiment, the stream distribution server 3 multiplexes FF data into stream data with a different ID. In the case of a conventional receiving device, the FF data is just discarded because of the different ID. On the other hand, the stream receiving device 1 can recognize the data as FF data. The stream distribution server 3 multiplexes the FF data based on the timestamp of the stream data.

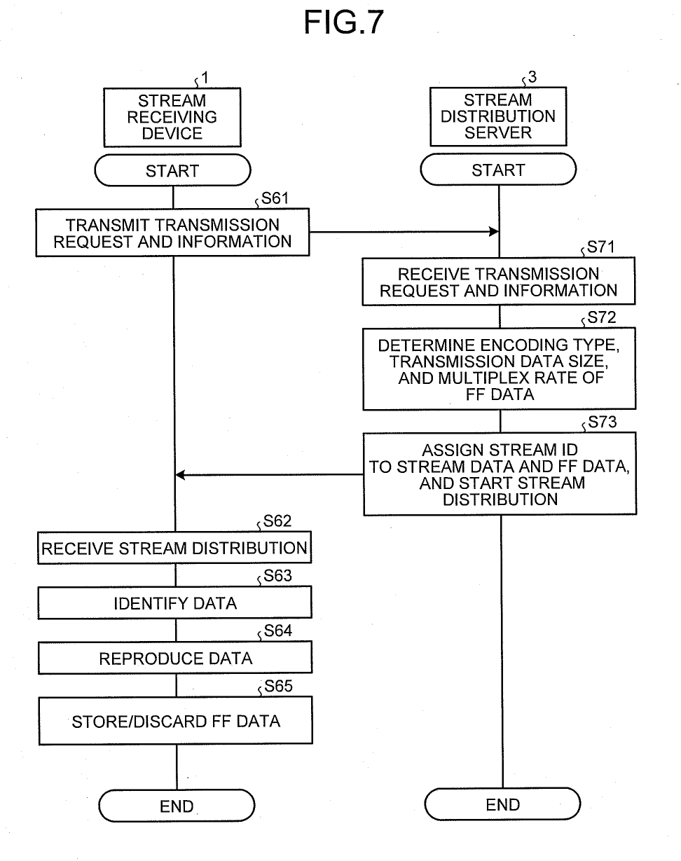

FIG. 7 is a sequence chart of a reproduction process. As illustrated in FIG. 7, the controller 13 of the stream receiving device 1 transmits a transmission request to the stream distribution server 3 together with various types of information as information on the stream receiving device 1. Examples of the information include built-in decoder information, the size of a buffer for FF data, and the bit rate of the network (S61).

Upon receipt of the transmission request and the information (S71), the controller 34 of the stream distribution server 3 determines encoding type, transmission data size, and multiplex rate of FF data based on the information received from the stream receiving device 1 (S72).

Thereafter, under the control of the controller 34, the data distribution processor 33 retrieves AV data (stream data) of video content from the data storage module 32 in response to the transmission request, and the encoder 42 generates FF data from the stream data. The controller 34 assigns a stream ID to each set of the AV data (stream data) and the FF data, and then starts stream distribution (S73).

Upon receipt of the stream distribution (S62), the controller 13 identifies the data based on the stream ID (S63).

After that, under the control of the controller 13, the AV decoder 12 decodes a video signal and an audio signal received through the stream distribution based on the stream ID, and reproduces the signals (S64). The controller 13 acquires the FF data based on the stream ID, and stores the FF data in the data buffer 23 as well as discarding FF data therefrom in synchronization with the stream data (S65).

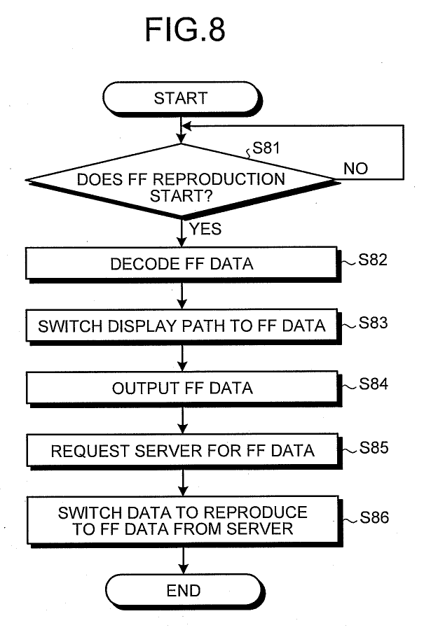

FIG. 8 is a flowchart of an FF reproduction process. As illustrated in FIG. 8, having received an instruction to start FF reproduction through an operation module (not shown) provided to the stream receiving device 1 (Yes at S81), under the control of the controller 13, the AV decoder 12 starts decoding FF data by the decoder 24 (S82). The selector 25 switches the display path to the FF data (S83), and outputs the FF data to the AV output device 4 (S84). Meanwhile, the controller 13 requests the stream distribution server 3 for FF data (S85), and switches data to reproduce to the FF data from the stream distribution server 3 (S86)

In this manner, the stream receiving device 1 requests the stream distribution server 3 for FF data upon start of FF reproduction. Thus, switching to the FF reproduction can be performed without a time lag.

In the above embodiments, the stream receiving device is described as a TV tuner by way of example and without limitation. The stream receiving device may be other devices such as a television receiver, a personal computer, a PDA, and a mobile telephone.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A stream distribution system, comprising:
a distribution server configured to stream and distribute content through a network; and
a stream receiving module configured to receive the content from the distribution server, wherein
the distribution server comprises a data distributor configured to distribute a stream data of the content in response to a transmission request from the stream receiving module together with low bit-rate playback data generated from the stream data, the low bit-rate playback data being tagged with a timestamp equivalent to a timestamp of the stream data, and
the stream receiving module comprises a reproducer configured to switch, upon receipt of the stream data and the low bit-rate playback data from the distribution server, between reproduction output of the stream data and reproduction output of the low bit-rate playback data while synchronizing the stream data and the low bit-rate playback data based on the timestamp.

2. A stream receiving device, comprising:
a receiver configured to receive stream data of content distributed from a distribution server via a network together with low bit-rate playback data generated from the stream data, the low bit-rate playback data being tagged with a timestamp equivalent to a timestamp of the stream data; and
a playback switch configured to switch between reproduction output of the stream data and reproduction output of the low bit-rate playback data while synchronizing the stream data and the low bit-rate playback data based on the timestamps.

3. The stream receiving device of claim 2, wherein the receiver is configured to connect via a second port other than a first port for receiving the stream data in order to receive the low bit-rate playback data.

4. The stream receiving device of claim 2, wherein
the stream data is assigned first identification information and the low bit-rate playback data is assigned second identification information different from the first identification information, and
the stream data comprises the low bit-rate playback data.

5. The stream receiving device of claim 2, wherein the low bit-rate playback data comprises a plurality of sets of low bit-rate playback data with a plurality of playback speeds.

6. A streaming reproduction method comprising:
receiving stream data of content distributed from a distribution server via a network together with low bit-rate playback data generated from the stream data, the low bit-rate playback data being tagged with a timestamp equivalent to a timestamp of the stream data; and
synchronizing the stream data and the low bit-rate playback data based on the timestamps and switching between reproduction output of the stream data and reproduction output of the low bit-rate playback data.
